(19) United States
(12) Patent Application Publication
(10) Pub. No.: US 2025/0146636 A1
(43) Pub. Date: May 8, 2025

(54) HEADLIGHT ASSEMBLY WITH ASYMMETRIC HIGH-DEFINITION LIGHTING UNITS

(71) Applicant: Autosystems, a division of Magna Exteriors Inc, Aurora (CA)

(72) Inventors: Adam L. Bushre, Saranac, MI (US); Gaurav Bhutani, Whitby (CA)

(21) Appl. No.: 18/885,001

(22) Filed: Sep. 13, 2024

Related U.S. Application Data
(60) Provisional application No. 63/595,461, filed on Nov. 2, 2023.

(51) Int. Cl. F21S 41/25; F21S 41/143; F21S 41/153; F21W 102/13; F21Y 115/10

(52) U.S. Cl. CPC F21S 41/25; F21S 41/143; F21S 41/153; F21W 2102/13; F21Y 2115/10

(57) ABSTRACT

A headlight assembly for a vehicle includes: first and second projector units each including a light source and an imaging lens assembly overlying the light source and configured to focus and direct light from the light source to produce a corresponding far-field illumination pattern. The light sources of each of the first and second projector units each include a plurality of pixel light sources. The second projector unit is angled relative to the first projector unit to cause the second far-field illumination pattern therefrom to partially overlap the first far-field illumination pattern from the first projector unit and to define an overlapping region and a combined illumination pattern having a smooth transition across boundaries where the far-field illumination patterns extends beyond the overlapping region, and causing the combined illumination pattern to appear to originate from a single source.

### CROSS REFERENCE TO RELATED APPLICATIONS

This U.S. utility patent application claims the benefit of U.S. Provisional Patent Application No. 63/595,461, filed Nov. 2, 2023, the contents of which is incorporated herein by reference in its entirety.

### FIELD

The present disclosure relates generally to lighting for motor vehicles. More specifically, the present disclosure relates to headlights for passenger vehicles, such as cars and trucks.

### BACKGROUND

Headlight assemblies for vehicles are subject to regulations regarding illumination patterns in order to illuminate a roadway ahead of the vehicle while also minimizing disruption to drivers of other vehicles, including oncoming traffic and vehicles traveling ahead of and in a same direction as the subject vehicle. Several different regulations and standards for headlight illumination may apply in different jurisdictions. Examples of such regulations and standards include ECE Created by the United Nations Economic Commission for Europe, United States Department of Transportation (DOT) for use in the U.S. & Canada, CCC certification for China, and U.S. Society of Automotive Engineers (SAE) standards.

Currently, optical designs use overlapping patterns to create a final light distribution in accordance with the desired illumination pattern. This can include using different optical projectors of differing prescriptions to provide spread as well as the higher intensity requirements in the central portions of most patterns. One projector may produce light central to the pattern with a very narrow spread but high intensity while the other will provide a wider spread with a lower intensity. By having multiple different projection units, each module may require special tools, which can increase cost, especially considering multiple components including lenses, housing, electronics, etc. One module on its own may not be capable of providing both the full spread required to meet the high beam requirements and still provide the highest intensity for a hot spot area of the final light distribution in accordance with the desired illumination pattern.

### SUMMARY

The present disclosure provides a headlight assembly for a vehicle. The headlight assembly includes: a first projector unit having a first light source and a first imaging lens assembly overlying the first light source and configured to focus and direct light from the first light source to produce a first far-field illumination pattern; and a second projector unit having a second light source and a second imaging lens assembly overlying the second light source and configured to focus and direct light from the second light source to produce a second far-field illumination pattern. Each of the first light source and the second light source includes a plurality of pixel light sources. The second projector unit is angled relative to the first projector unit to cause the second far-field illumination pattern to partially overlap the first far-field illumination pattern to define an overlapping region, with the first projector unit and the second projector unit being operable together to produce region of higher intensity within the overlapping region. Each of the first far-field illumination pattern and the second far-field illumination pattern are controllable to define a combined illumination pattern having a smooth transition across each of a first boundary where the first far-field illumination pattern extends beyond the overlapping region, and across a second boundary where the second far-field illumination pattern extends beyond the overlapping region, and causing the combined illumination pattern to appear to originate from a single source.

The present disclosure also provides a headlight system for a vehicle. The headlight system includes: a first projector unit having a first light source and a first imaging lens assembly overlying the first light source and configured to focus and direct light from the first light source to produce a first far-field illumination pattern; and a second projector unit having a second light source and a second imaging lens assembly overlying the second light source and configured to focus and direct light from the second light source to produce a second far-field illumination pattern. Each of the first light source and the second light source includes a plurality of pixel light sources. The second projector unit is angled relative to the first projector unit to cause the second far-field illumination pattern to partially overlap the first far-field illumination pattern to define an overlapping region, with the first projector unit and the second projector unit being operable together to produce region of higher intensity within the overlapping region. The headlight system further includes a controller configured to command the first light source to cause the first projector unit to produce the first far-field illumination pattern and to command the second projector unit to produce the second far-field illumination pattern, with the first far-field illumination pattern and the second far-field illumination pattern together defining a combined illumination pattern having a smooth transition across each of a first boundary where the first far-field illumination pattern extends beyond the overlapping region, and across a second boundary where the second far-field illumination pattern extends beyond the overlapping region.

These and other aspects of the present disclosure are disclosed in the following detailed description of the embodiments, the appended claims, and the accompanying figures.

### BRIEF DESCRIPTION OF THE DRAWINGS

Further details, features and advantages of designs of the invention result from the following description of embodiment examples in reference to the associated drawings.

FIG. 1 shows a schematic block diagram of a vehicle with two headlight assemblies, in accordance with an aspect of the present disclosure;

FIG. 2 shows a combined illumination pattern, in accordance with an aspect of the present disclosure;

FIG. 3 shows a cross-sectional side view of a first projector unit for a headlight assembly, in accordance with an aspect of the present disclosure;

FIG. 4 shows a wire-frame top view of a first headlight assembly in accordance with an aspect of the present disclosure;

FIG. 5 shows a wire-frame top view of a second headlight assembly in accordance with an aspect of the present disclosure; and

FIG. 6 shows a first low beam illumination pattern produced by the first projector unit, in accordance with an aspect of the present disclosure;

FIG. 7 shows a second low beam illumination pattern produced by the second projector unit, in accordance with an aspect of the present disclosure;

FIG. 8 shows a foreground beam pattern, in accordance with an aspect of the present disclosure;

FIG. 9 shows a combined low beam illumination pattern including each of the first low beam illumination pattern, the second low beam illumination pattern, and the foreground beam pattern, in accordance with an aspect of the present disclosure;

FIG. 10A shows a driver's view of a roadway with a composite of two combined illumination patterns produced by two headlight assemblies, in accordance with an aspect of the present disclosure;

FIG. 10B shows a top-down birds-eye view of the roadway with the composite of the two combined illumination patterns shown in FIG. 10A.

FIG. 11 shows a first high beam illumination pattern produced by the first projector unit, in accordance with an aspect of the present disclosure;

FIG. 12 shows a combined high-beam illumination pattern including each of the first high beam illumination pattern and the second high beam illumination pattern from two projector units in one headlight assembly;

FIG. 13 shows a combined high beam illumination pattern including each of the first high beam illumination pattern, the second high beam illumination pattern, and the foreground beam pattern, all from one headlight assembly, in accordance with an aspect of the present disclosure; and

FIG. 14 shows a composite high beam illumination pattern including each of the first high beam illumination pattern and the second high beam illumination pattern from two projector units in each of two headlight assemblies, in accordance with an aspect of the present disclosure.

### DETAILED DESCRIPTION

Referring to the drawings, the present invention will be described in detail in view of following embodiments.

It is an objective of the invention of the present disclosure to provide a single module with a field of view of a particular size which can be aligned at a particular angle with a second same module to provide an asymmetric overlap to meet “hot spot” intensity requirements while also providing a spread width in accordance with design requirements for a particular vehicle, such as about 20 degrees.

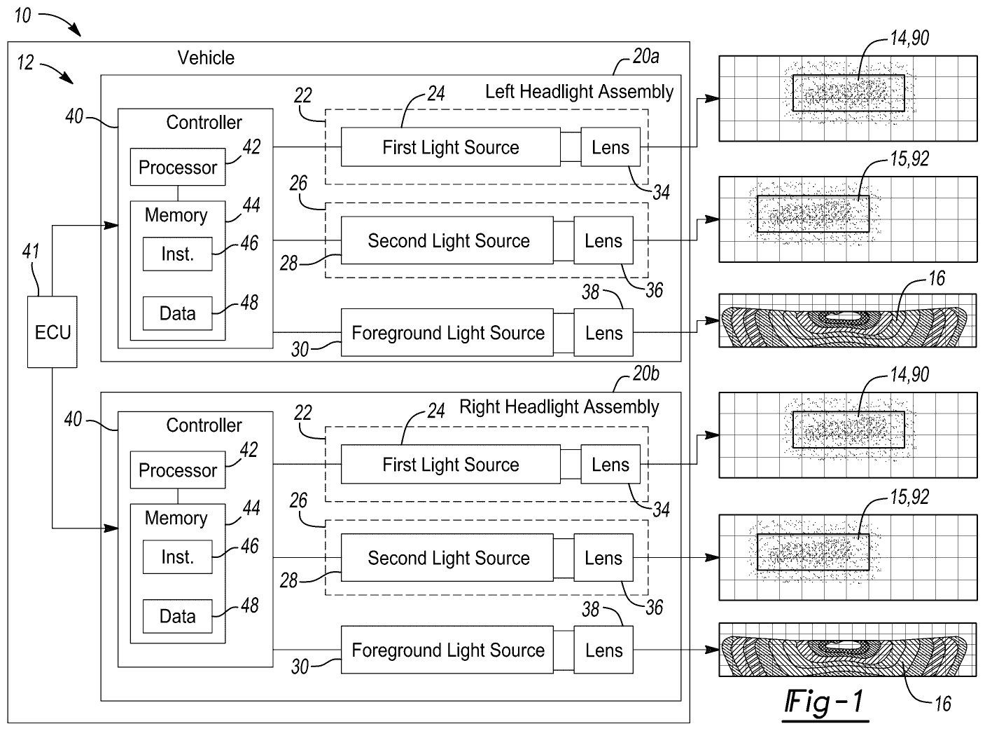

FIG. 1 shows a schematic block diagram of a vehicle 10 with a lighting system 12, according to an aspect of the present disclosure. The vehicle 10 may be a motor vehicle, such as a passenger car or truck. However, the headlamp assembly of the present disclosure may be applicable to other types of vehicles, such as commercial trucks, busses, trains, etc. The vehicle 10 with the lighting system 12 of the present disclosure may also be referred to as the ego vehicle or the subject vehicle. The lighting system 12 includes a left-side headlight assembly 20a and a right-side headlight assembly 20b. Each of the headlight assemblies 20a, 20b may be similar or identical to one-another. In some embodiments, the headlight assemblies 20a, 20b may include similar or identical internal components and different external components, such as a housing that is configured to fit within the structure on the corresponding side of the vehicle 10.

As shown in FIG. 1, each of the headlight assemblies 20a, 20b includes a first projector unit 22, a second projector unit 26, and a foreground projector unit 30,38. The first projector unit 22 includes a first light source 24 and a first imaging lens assembly 34 overlying the first light source 24 and configured to focus and direct light from the first light source 24 to produce a first far-field illumination pattern 14,90. The second projector unit 26 includes a second light source 28 and a second imaging lens assembly 36 overlying the second light source 28 and configured to focus and direct light from the second light source 28 to produce a second far-field illumination pattern 15,92.

The foreground projector unit 30,38 includes a foreground light source 30 coupled to a third lens assembly 38 and configured to generate a foreground beam pattern 16, which may also be called a base beam pattern, and which illuminates a wide area below the first far-field illumination pattern 14,90 and the second far-field illumination pattern 15,92. For example, the foreground beam pattern 16 may extend across a 110-degree spread from −55-degrees to +55-degrees. However, the foreground beam pattern 16 may have a different spread, which may depend on a given implementation.

In some embodiments, the first projector unit 22 and the second projector unit 26 may each have identical constructions. For example, they may each include identical hardware for their respective light source 24, 28 and for their respective imaging lens assembly 34, 36.

Each of the first light source 24 and the second light source 28 includes a plurality of pixel light sources. The plurality of pixel light sources may include a 2-diminensional array of pixels. For example, the light sources 24, 28 may each include a digital micromirror device (DMD) and/or a diode matrix of light emitting diode (LED) elements. In some embodiments, each of the light sources 24, 28 includes at least 3,000 of the pixel light sources. In some embodiments, each of the light sources 24, 28 includes at least 15,000 of the pixel light sources. However, the light sources 24, 28 may include any number of pixel light sources, with a greater number of pixels providing a greater resolution.

Each of the headlight assemblies 20a, 20b also includes a controller 40 in communication with each of the first light source 24, and the second light source 28. The controller 40 may also be called a light driving module (LDM), a headlamp smart lighting driver or a headlamp smart LED driver. The controller 40 may be configured to control patterns of light generated by the first projector unit 22 and the second projector unit 26. The controller 40 may provide signals to control a brightness level of each of the pixel light sources. For example, the controller 40 may control brightness levels of each of the pixel light sources using on/off signals and with pulse-width modulation (PWM) switching.

The controller 40 includes a processor 42 coupled to a storage memory 44. The storage memory 44 includes instruction storage 46 storing instructions, such as program code for execution by the processor 42. The storage memory 44 also includes data storage 48 for holding data for use by the processor 42.

The vehicle 10 also includes an electronic control unit (ECU) 41, such as a body control module (BCM), that is in functional communication with the controllers 40 of each of the the headlight assemblies 20a, 20b and configured to communicate one or more signals for controlling operation of the headlight assemblies. For example, the ECU 41 may direct the headlight assemblies 20a, 20b to operate in a high-beam mode or in a low-beam mode. The ECU 41 may provide additional messages or commands to the controllers 40, such as particular regions to illuminate or to dim in order to reduce glare directed toward other traffic.

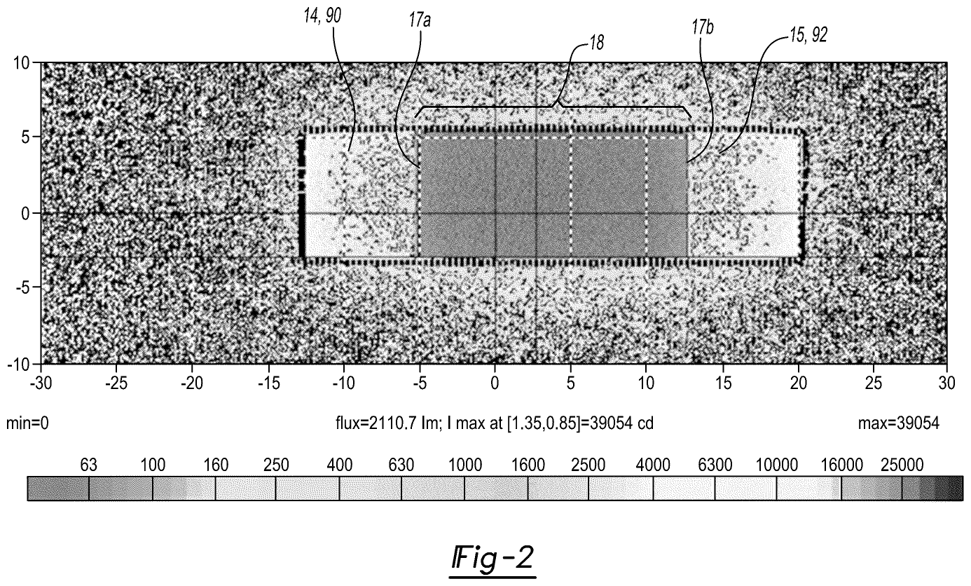

FIG. 2 shows a combined illumination pattern produced by the first projector unit 22 and the second projector unit 26. The second projector unit 26 is angled relative to the first projector unit 22 to cause the second far-field illumination pattern 15,92 to partially overlap the first far-field illumination pattern 14,90 to define an overlapping region 18. The first projector unit 22 and the second projector unit 26 are operable together to produce region of higher intensity within the overlapping region 18. In other words, the a lighting system 12 uses the two projector units 22, 26 angled relative to one another to provide the overlapping region which can have a higher intensity than either of the two projector units 22, 26 could produce, alone. As shown, a first boundary 17a defines a left-side edge of the overlapping region 18, and the first far-field illumination pattern 14,90 extends to the left beyond the first boundary 17a. As also shown in FIG. 2, a second boundary 17b defines a right-side edge of the overlapping region 18, and the second far-field illumination pattern 15,92 extends to the right beyond the second boundary 17b. The far-field illumination patterns 14,90, 15,92 shown in FIG. 2 represents a pattern produced by the right-side headlight assembly 20b and has a spread from about-13-degrees (i.e. 13-degrees to the left of center) to +20-degrees (i.e. 20-degrees to the right of center). A similar pattern may be produced by the left-side headlight assembly 20a, but with a spread out to −20-degrees. Together, the two headlight assemblies 20a, 20b may provide low-beam illumination across a 40-degree spread from −20-degrees to +20-degrees.

The far-field illumination patterns 14,90 and 15,92 shown in FIGS. 1-2 are each full patterns, including each of the pixel light sources 24, 28 operated at a full brightness. Such a full pattern may be used for demonstration purposes or for other purposes, such as calibration and alignment. However, during normal operation, the pixel light sources 24, 28 may be operated with reduced brightness to define low beam illumination patterns 14,15 and/or high-beam illumination patterns 90,92 and to cause the boundaries 17a, 17b to have a smooth transition that is not discernable to a viewer.

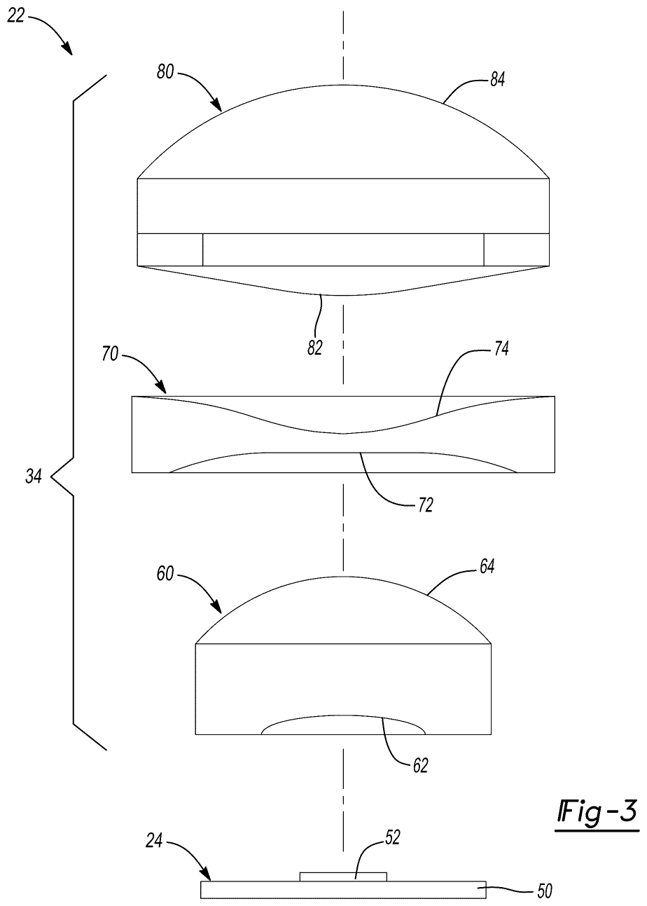

FIG. 3 shows a cross-sectional side view of the first projector unit 22, including the first imaging lens assembly 34. The first imaging lens assembly 34 may modify a pattern of light produced by the first light source 24, such as by stretching the pattern and/or by blending some amount of light between the pixel light sources. FIG. 3 also shows the first light source 24 including a printed circuit board (PCB) 50 with a light source device 52 disposed thereupon. The light source device 52 may include, for example, a digital micromirror device (DMD) and/or a diode matrix of light emitting diode (LED) elements. However, the light source device 52 may include any device capable of providing the pixel light sources.

As shown in FIG. 3, the first imaging lens assembly 34 includes a first lens element 60 adjacent to the PCB 50. The first lens element 60 defines a first input surface 62 receiving light from the light source device 54. The first lens element 60 also defines and a first output surface 64 for outputting light. The First imaging lens assembly 34 also includes a second lens element 70 overlying the first lens element 60, with the first lens element 60 disposed between the second lens element 70 and the PCB 50. The second lens element 70 defines a second input surface 72 receiving light from the first output surface 64 of the first lens element 60. The second lens element 70 also defines a second output surface 74 for outputting light. As shown, the first input surface 62, the second input surface 72, and the second output surface 74 each have a concave shape, and the first output surface 64 has a convex shape. However, either or both of the first lens element 60 and/or the second lens element 70 may have a different shape.

The First imaging lens assembly 34 also includes a third lens element 80 overlying the second lens element 70, with the second lens element 70 disposed between the third lens element 80 and the first lens element 60. The third lens element 80 defines a third input surface 82 receiving light from the second output surface 74 of the second lens element 70. The third lens element 80 also defines a third output surface 84 for outputting light. As shown, the third input surface 82 and the third output surface 84 each have a convex shape. However, either or both of the third input surface 82 and the third output surface 84 may have a different shape.

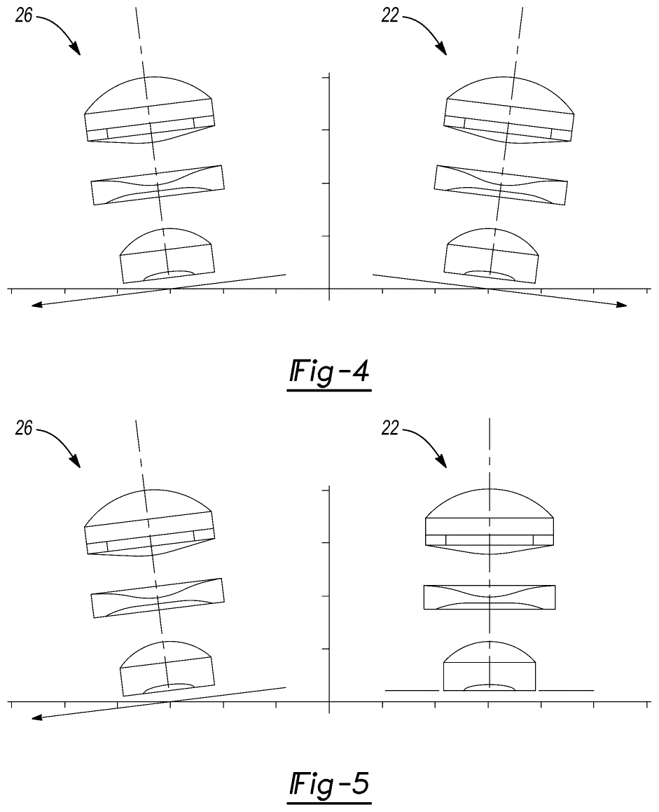

FIG. 4 shows a wire-frame top view of a first headlight assembly. The first headlight assembly as shown in FIG. 4 may be used for either or both of the left-side headlight assembly 20a and/or the right-side headlight assembly 20b. As shown in FIG. 4, the first headlight assembly includes the first projector unit 22 and the second projector unit 26 each angled outwardly from a direction of travel of the vehicle.

FIG. 5 shows a wire-frame top view of a second headlight assembly. The second headlight assembly as shown in FIG. 5 may be used for either or both of the left-side headlight assembly 20a and/or the right-side headlight assembly 20b. As shown in FIG. 5, the first projector unit 22 is pointed in a direction of travel of the vehicle, and the second projector unit 26 is angled outwardly.

In some embodiments, the second projector unit 26 is angled at about 7.5 degrees relative to the first projector unit 22. However, the angle between the projector units 22, 26 may depend on system design requirements, such as overall pattern width.

Each of the projector units 22, 26 is operable to generate the corresponding far-field illumination patterns 14,90, 15,92 to define a combined illumination pattern having a smooth transition across each of the first boundary 17a where the first far-field illumination pattern 14,90 extends beyond the overlapping region 18, and across the second boundary 17b where the second far-field illumination pattern 15,90 extends beyond the overlapping region 18, and causing the combined illumination pattern to appear to originate from a single source. For example, the controller 40 may command the first and second light sources 24, 28 to generate specific illumination patterns that correspond to the desired far-field illumination patterns 14,90, 15,92 to define a combined illumination pattern having the smooth transitions across the boundaries 17a, 17b.

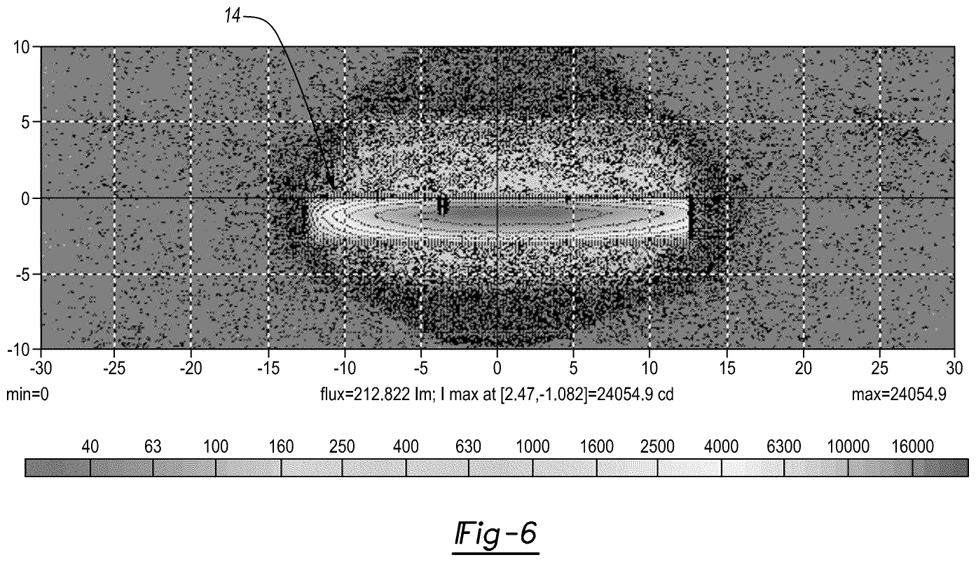

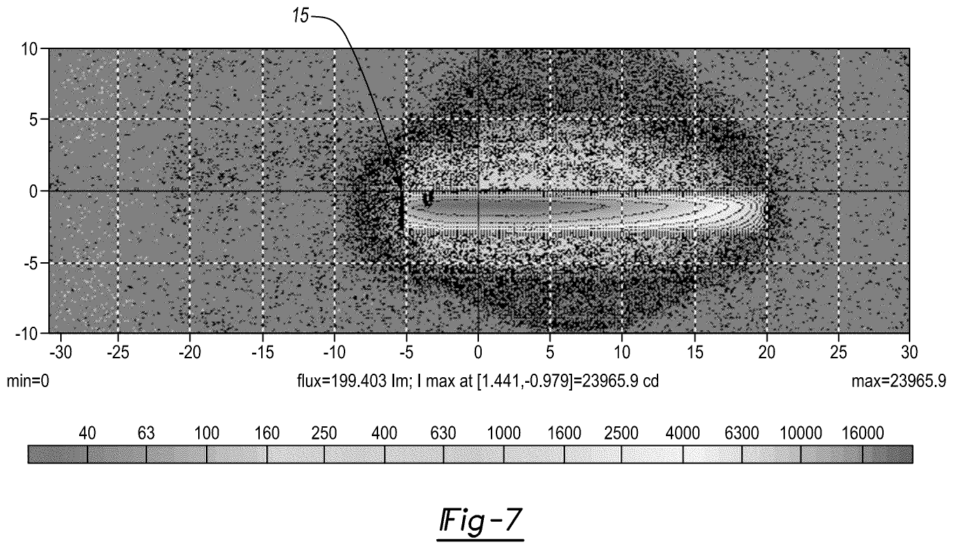

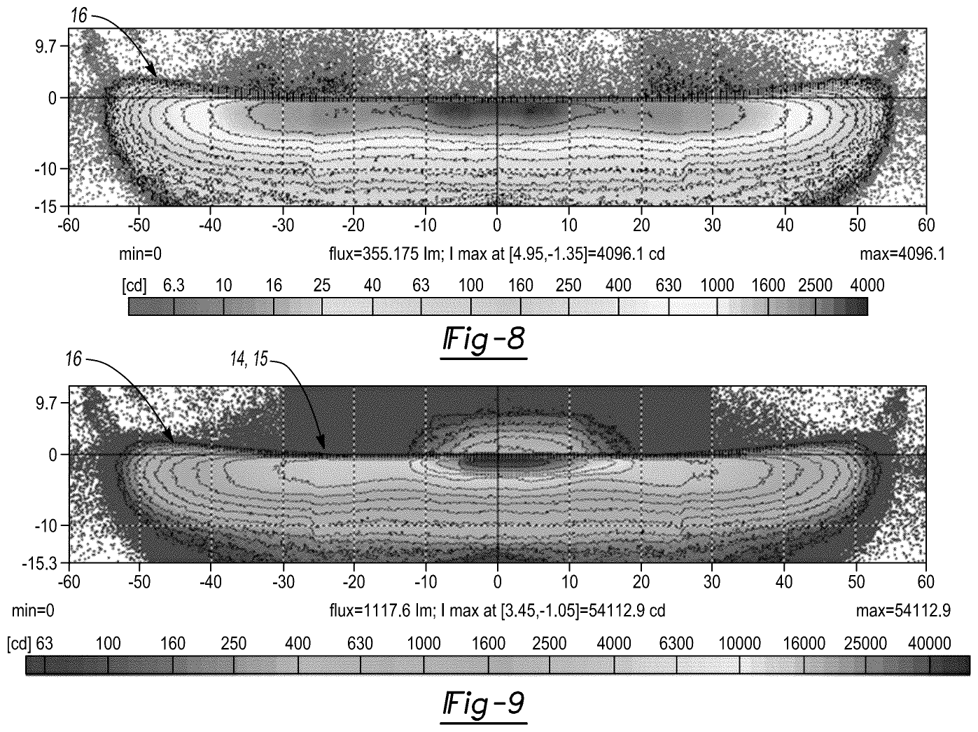

FIG. 6 shows a first low beam illumination pattern 14 produced by the first projector unit 22, FIG. 7 shows a second low beam illumination pattern 15 produced by the second projector unit 26, FIG. 8 shows a foreground beam pattern 16, produced by the foreground projector unit 30,38, and FIG. 9 shows a combined low beam illumination pattern 14,15,16 including each of the first low beam illumination pattern 14, the second low beam illumination pattern 15, and the foreground beam pattern 16 and having the smooth transitions across the boundaries 17a, 17b. Note that FIGS. 8-9 have different scales, with FIG. 8 having coloration corresponding to luminous intensity levels 0-4096 candela (cd), and with FIG. 9 having coloration corresponding to luminous intensity levels 0-54,113 candela (cd). As shown, the boundaries 17a, 17b are not discernable on FIG. 9. The combined low beam illumination pattern 14,15,16 shown on FIG. 9 may appear to originate from a single source.

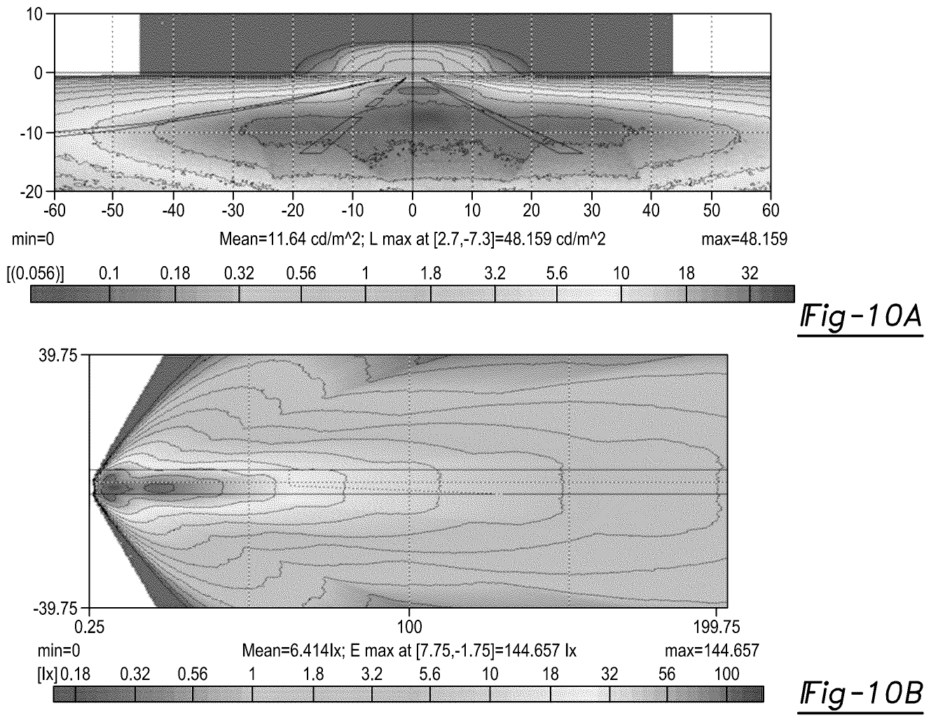

FIG. 10A shows a driver's view of a roadway with a composite of two combined illumination patterns produced by two headlight assemblies 20a, 20b of the present disclosure. FIG. 10B shows a top-down birds-eye view of the roadway with the composite of the two combined illumination patterns shown in FIG. 10A.

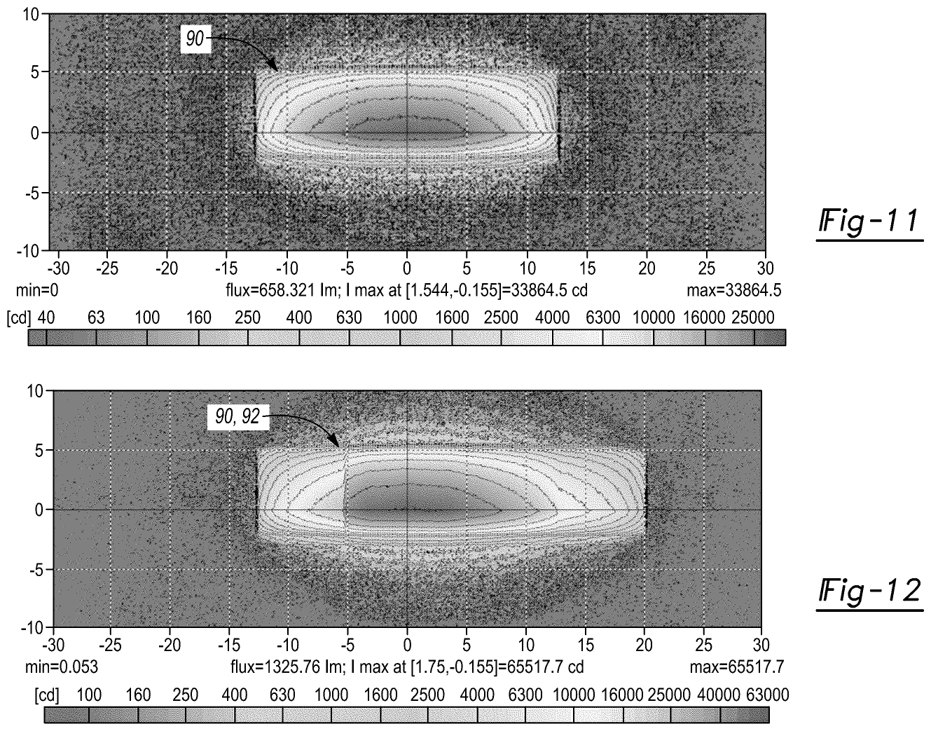

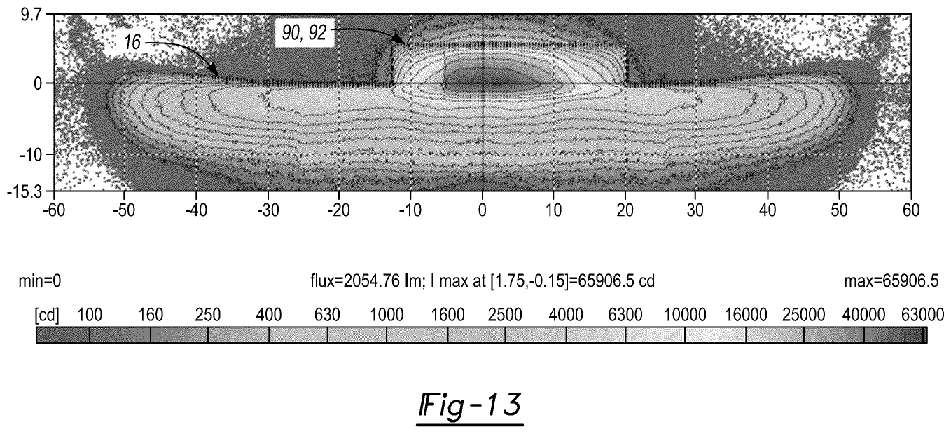

FIG. 11 shows a first high beam illumination pattern 90 produced by the first projector unit 22. FIG. 12 shows a combined high-beam illumination pattern 90,92 including each of the first high beam illumination pattern 90 and the second high beam illumination pattern 92 from two projector units 22, 26 in one of the headlight assemblies 20a, 20b. FIG. 13 shows a combined high beam illumination pattern 16,90,92, including each of the first high beam illumination pattern 90, the second high beam illumination pattern 92, and the foreground beam pattern 16, all from one of the headlight assemblies 20a, 20b.

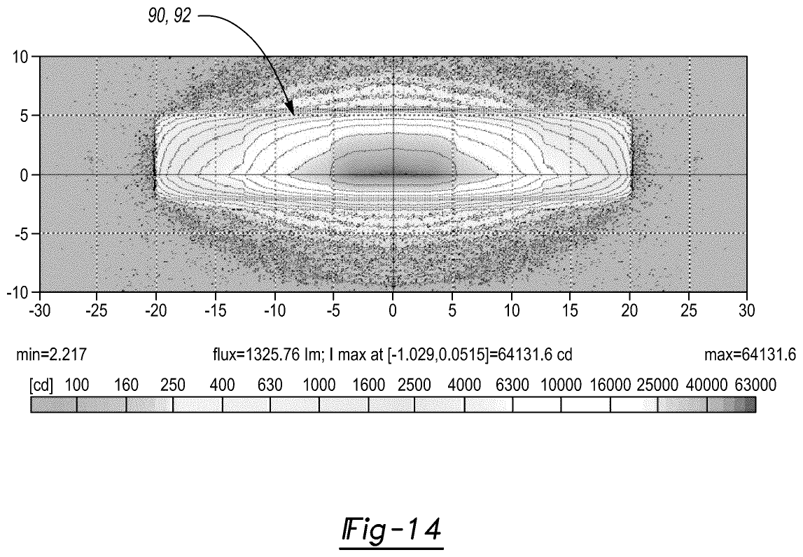

FIG. 14 shows a composite high beam illumination pattern 90,92, including each of the first high beam illumination pattern 90 and the second high beam illumination pattern 92 from two projector units 22,26 in each of two of the headlight assemblies 20a, 20b. The illumination patterns 14,15,16,90,92 shown in each of FIGS. 6-14 include isometric lines of equal light intensity at far-field distance. The systems and methods of the present disclosure are configured to control the light sources 24, 28, 30 to generate one or more desired illumination patterns, such as the illumination patterns shown in the FIGS., with the isometric lines spanning across the boundaries 17a, 17b.

The lighting system 12 of the present disclosure may include Pixel-based light light sources 24, 28 each having over 15K elements of 50 or less microns in size are used along with a set of lenses to produce a field of view. This field of view in the design is 8.5 by 25.5 degrees which leaves about 0.1-degree projected pixels into the far field and intensity values of up to around 35 Kcd. This field of view has a horizontal spread is approximately 12.75 degrees left and right. High beam test points go out to 12 degrees left and right however, automakers have design standards which exceed the legal requirements and require high beam spread out to angles of 20 or more degrees. Spreading the light out further to obtain the pattern width desired results in a lower maximum intensity. Legal requirement for intensity is 40 Kcd however again the automakers want more and require 65 Kcd to 75 Kcd.

Using the two projector units 22, 26, aligned at 7.5 degrees horizontally to each other with the car axis central between the two provides overlap in the central portion of the pattern 5 left to 5 right. In this central area the two patterns overlap to obtain the high intensity requirements and in the areas of non-overlap the spread is achieved.

An alternative arrangement, as shown in FIG. 5 is to maintain one of the two projector units 22, 26 pointing down car axis and rotate only the second module 7.5 degrees which then provides an asymmetric pattern 12.75 degrees one direction and 20 degrees the other with overlapping areas of 5 degrees in one direction and 12.75 degrees the other.

Two dimming matrices may be used through software to adjust performance of each of the two projector units 22, 26 so they produce the patterns desired. The right side of the car and left side of the car with asymmetric designs then work together to perform the full road illumination.

The system, methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or alternatively, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices as well as heterogeneous combinations of processors processor architectures, or combinations of different hardware and software, or any other machine capable of executing program instructions.

Thus, in one aspect, each method described above and combinations thereof may be embodied in computer executable code that, when executing on one or more computing devices performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

The foregoing description is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A headlight assembly for a vehicle, comprising:
a first projector unit having a first light source and a first imaging lens assembly overlying the first light source and configured to focus and direct light from the first light source to produce a first far-field illumination pattern; and
a second projector unit having a second light source and a second imaging lens assembly overlying the second light source and configured to focus and direct light from the second light source to produce a second far-field illumination pattern,
wherein each of the first light source and the second light source includes a plurality of pixel light sources,
wherein the second projector unit is angled relative to the first projector unit to cause the second far-field illumination pattern to partially overlap the first far-field illumination pattern to define an overlapping region, with the first projector unit and the second projector unit being operable together to produce region of higher intensity within the overlapping region, and
wherein each of the first far-field illumination pattern and the second far-field illumination pattern are controllable to define a combined illumination pattern having a smooth transition across each of a first boundary where the first far-field illumination pattern extends beyond the overlapping region, and across a second boundary where the second far-field illumination pattern extends beyond the overlapping region, and causing the combined illumination pattern to appear to originate from a single source.

2. The headlight assembly of claim 1, wherein the first projector unit and the second projector unit each have identical constructions.

3. The headlight assembly of claim 1, further including a controller in communication with the first light source to cause the first projector unit to produce the first far-field illumination pattern in accordance with the combined illumination pattern having the smooth transitions across each of the first boundary and the second boundary.

4. The headlight assembly of claim 3, wherein the controller is also in communication with the second light source to cause the second projector unit to produce the second far-field illumination pattern in accordance with the combined illumination pattern having the smooth transitions across each of the first boundary and the second boundary.

5. The headlight assembly of claim 1, wherein each of the first light source and the second light source includes a digital micromirror device (DMD) defining the plurality of pixel light sources.

6. The headlight assembly of claim 1, wherein each of the first light source and the second light source includes a diode matrix of light emitting diode (LED) elements defining the plurality of pixel light sources.

7. The headlight assembly of claim 1, wherein the plurality of pixel light sources includes at least 3,000 of the pixel light sources.

8. The headlight assembly of claim 1, wherein the plurality of pixel light sources includes at least 15,000 of the pixel light sources.

9. The headlight assembly of claim 1, wherein each of the first projector unit and the second projector unit is angled outwardly from a direction of travel of the vehicle.

10. The headlight assembly of claim 1, wherein one of the first projector unit and the second projector unit is pointed in a direction of travel of the vehicle, and wherein the other one of the first projector unit and the second projector unit is angled outwardly.

11. The headlight assembly of claim 1, wherein the second projector unit is angled at least about 7.5 degrees relative to the first projector unit.

12. The headlight assembly of claim 1, wherein the combined illumination pattern has a width of at least about 20-degrees.

13. The headlight assembly of claim 1, wherein at least one of the first far-field illumination pattern or the second far-field illumination pattern includes a high-beam pattern that extends above a horizon.

14. The headlight assembly of claim 13, wherein both of the first far-field illumination pattern and the second far-field illumination pattern together define the high-beam pattern that extends above the horizon.

15. A headlight system for a vehicle, comprising:
a first projector unit having a first light source and a first imaging lens assembly overlying the first light source and configured to focus and direct light from the first light source to produce a first far-field illumination pattern;
a second projector unit having a second light source and a second imaging lens assembly overlying the second light source and configured to focus and direct light from the second light source to produce a second far-field illumination pattern,
wherein each of the first light source and the second light source includes a plurality of pixel light sources,
wherein the second projector unit is angled relative to the first projector unit to cause the second far-field illumination pattern to partially overlap the first far-field illumination pattern to define an overlapping region, with the first projector unit and the second projector unit being operable together to produce region of higher intensity within the overlapping region; and
a controller configured to command the first light source to cause the first projector unit to produce the first far-field illumination pattern and to command the second projector unit to produce the second far-field illumination pattern, with the first far-field illumination pattern and the second far-field illumination pattern together defining a combined illumination pattern having a smooth transition across each of a first boundary where the first far-field illumination pattern extends beyond the overlapping region, and across a second boundary where the second far-field illumination pattern extends beyond the overlapping region.

16. The headlight system of claim 15, wherein the first projector unit and the second projector unit each have identical constructions.

17. The headlight system of claim 15, wherein each of the first light source and the second light source includes a digital micromirror device (DMD) defining the plurality of pixel light sources.

18. The headlight system of claim 15, wherein each of the first light source and the second light source includes a diode matrix of light emitting diode (LED) elements defining the plurality of pixel light sources.

19. The headlight system of claim 15, wherein the plurality of pixel light sources includes at least 3,000 of the pixel light sources.

20. The headlight system of claim 15, wherein the second projector unit is angled at least about 7.5 degrees relative to the first projector unit.
